(19) United States
(12) Patent Application Publication
(10) Pub. No.: US 2026/0292402 A1
(43) Pub. Date: Sep. 24, 2026

(54) HIGH AND LOW DUAL-FREQUENCY COMPOSITE LOUDSPEAKER UNIT AND AUDIO DEVICE

(71) Applicant: Shenzhen Weile Electronics Co.Ltd, Shenzhen (CN)

(72) Inventors: Hua Wang, Shenzhen (CN); Sheng Chen, Shenzhen (CN); Han Wu, Shenzhen (CN); Jiandong Feng, Shenzhen (CN)

(21) Appl. No.: 19/689,308

(22) Filed: May 27, 2026

(30) Foreign Application Priority Data
Feb. 11, 2026 (CN) 202620210051.5
May 13, 2026 (CN) 202610660813.6

(51) Int. Cl. H04R 3/14; H04R 1/06; H04R 1/24; H04R 9/02; H04R 9/06; H04R 11/02

(52) U.S. Cl. CPC H04R 3/14; H04R 1/06; H04R 1/24; H04R 9/025; H04R 9/06; H04R 11/02

(57) ABSTRACT

This application relates to a high and low dual-frequency composite loudspeaker unit and an audio device. The loudspeaker unit includes a low-frequency loudspeaker component and a high-frequency loudspeaker component. An independent high-frequency loudspeaker component is integrated on the central axis of the low-frequency loudspeaker component, and the high-frequency loudspeaker component is connected with the crossover circuit board through independent lead wires, and works together with the low-frequency loudspeaker component through the crossover circuit board.

### CROSS-REFERENCE TO RELATED APPLICATIONS

This application claims priority to Chinese Patent Application No. 202620210051.5, filed on Feb. 11, 2026 and Chinese Patent Application No. 202610660813.6, filed on May 13, 2026, which is hereby incorporated by reference in its entirety.

### TECHNICAL FIELD

This application belongs to the technical field of electro-acoustic conversion devices, and relates to a high and low dual-frequency composite loudspeaker unit mainly used for audio devices such as earphones.

### BACKGROUND

A single moving-coil loudspeaker unit is usually used in an earphone in the prior art and is responsible for reproducing sounds in all frequency bands. However, it is difficult for a single loudspeaker unit to perfectly balance an impact of low frequencies and details and extensions of high frequencies simultaneously. Low frequencies are prone to problems such as insufficient depth and distortion, and high frequencies are prone to insufficient resolution and limited extension, resulting in significant constraints on overall sound quality performance of the earphone.

In the field of in-ear earphones, a loudspeaker unit has a relatively small size and can be flexibly disposed in a flat manner in an earphone housing to achieve dual-unit or multi-unit high and low frequency crossover for sound reproduction. For example, in-ear earphones produced by Apple Inc. improve the sound quality performance in all frequency bands to a certain extent through reasonable unit layout and crossover design.

However, in the field of headphones, loudspeaker units are limited by both acoustic performance and ergonomics, and loudspeaker units with diameters between 30 mm and 50 mm are often used. A loudspeaker unit with a diameter less than 30 mm has defects that an effective radiation area of a vibrating diaphragm is too small, air displacement is insufficient, a low-frequency depth is weak, an atmosphere is lacking, and a sound field diffusion angle is narrow, which cannot reflect specific spatial advantages of the headphone; and furthermore, specifications of a magnetic circuit and a voice coil are limited, making it difficult to balance sensitivity, bandwidth, and sound quality performance; and because structures such as an earcup and a headband of the headphone are fixed, if a small-size unit is accommodated, a waste of hardware structures is caused, and structural advantages of the headphone cannot be exerted. A loudspeaker unit with a diameter greater than 50 mm has defects that a physical size of the unit is too large, and volumes of an earcup and a housing need to be increased correspondingly, which violates an ergonomic design and leads to a surge in weight of the entire earphone; long-term wearing may easily cause discomforts such as head pinching and ear pressure; moreover, a vibration inertia of a large vibrating diaphragm is large, a transient response deteriorates, a segmented vibration is severe, and high frequencies are prone to splitting and distortion; and furthermore, a cavity acoustics tuning difficulty is increased exponentially, problems such as standing waves and harmonic peaks are obvious, driving difficulty and material and mold costs are also increased significantly, a marginal effect of sound quality improvement is extremely low, and a cost-effectiveness is extremely poor.

In the field of headphones, a reasonable arrangement of a tweeter unit and a woofer unit has long been a technical problem in the industry: Firstly, an internal space of an earcup of a headphone is limited, and an overall occupied area of the unit cannot be increased, so that a common flat arrangement manner for in-ear earphones is often inadvisable; and secondly, if a coaxial arrangement manner is used, a thickness of the headphone will be additionally increased, affecting wearing comfort and overall aesthetic design of a product.

It should be noted that an overall thickness of the loudspeaker unit with a diameter between 30 mm and 50 mm is usually between 8 mm and 18 mm. This thickness range is a reasonable range that is suitable for the earcup space of the headphone and balances wearing comfort and acoustic performance. How to simultaneously place a low-frequency loudspeaker unit and a high-frequency loudspeaker unit without changing the thickness and diameter of an original unit has become a key to solving a problem of dual-unit arrangement of the headphone.

In conclusion, there are still many defects in arrangement and structural design of loudspeaker units of existing headphones, and thus, it is urgent to provide a high and low dual-frequency composite loudspeaker unit and an audio device that can solve the above problems and balance sound quality, wearing comfort, assembly convenience, and mass production feasibility.

### SUMMARY

To overcome a problem of difficulty in balancing high and low frequencies of a single acoustic unit in related technologies, this application aims to provide a high and low dual-frequency composite loudspeaker unit.

This application is implemented through the following technical solution.

The technical solution provides a high and low dual-frequency composite loudspeaker unit, including a low-frequency loudspeaker component and a high-frequency loudspeaker component, where the low-frequency loudspeaker component includes a first housing, the first housing is provided with a bracket, a low-frequency sound cavity is formed between the bracket and the first housing, the high-frequency loudspeaker component is disposed on the bracket, and the high-frequency loudspeaker component is located on a central axis of a vibrating diaphragm or a central axis of a magnetic circuit of the low-frequency loudspeaker component; and
the high and low dual-frequency composite loudspeaker unit further includes a crossover circuit board disposed on the first housing, the low-frequency loudspeaker component and the high-frequency loudspeaker component are electrically connected to the crossover circuit board respectively, the low-frequency loudspeaker component is configured to reproduce a low-frequency part in an audio signal, and the high-frequency loudspeaker component is configured to reproduce a high-frequency part in the audio signal.

According to the high and low dual-frequency composite loudspeaker unit in the technical solution, an independent high-frequency loudspeaker component is integrated on the central axis of the low-frequency loudspeaker component, and the high-frequency loudspeaker component is connected to the crossover circuit board through independent lead wires, and works together with the low-frequency loudspeaker component through the crossover circuit board.

The technical solution integrates generation sources of low-frequency and high-frequency sound waves in a physical structure while maintaining independent electro-acoustic conversion characteristics thereof, so that the low-frequency part can focus on expressing rich and deep bass, and the high-frequency part can accurately restore delicate high-frequency details, thereby significantly improving overall sound quality performance width and clarity of an earphone without significantly increasing a volume of the earphone.

In an implementation of the technical solution, the bracket is provided with a plurality of low-frequency sound holes, the low-frequency sound holes are configured to communicate with the low-frequency sound cavity, and all the low-frequency sound holes are uniformly distributed around the high-frequency loudspeaker component.

In an implementation of the technical solution, a concave cavity is formed in a central position of the bracket, the high-frequency loudspeaker component is accommodated in the concave cavity, and the concave cavity is not in communication with the low-frequency sound cavity.

In an implementation of the technical solution, the bracket is further provided with a protective cover, the protective cover covers the concave cavity, and the protective cover is provided with high-frequency sound holes.

In an implementation of the technical solution, the low-frequency loudspeaker component is a balanced armature type loudspeaker or a moving-coil loudspeaker.

In an implementation of the technical solution, the high-frequency loudspeaker component is a balanced armature type loudspeaker or a moving-coil loudspeaker.

In an implementation of the technical solution, the low-frequency loudspeaker component includes a first housing, a first vibrating diaphragm, and a first magnet, where the first vibrating diaphragm and the first magnet are disposed on the first housing, the first vibrating diaphragm is provided with a first voice coil, and the first voice coil is electrically connected to the crossover circuit board.

In an implementation of the technical solution, the low-frequency loudspeaker component further includes a magnetic yoke, the first magnet is disposed on the magnetic yoke, the magnetic yoke is disposed on the first housing, an annular gap is formed between the magnetic yoke and the first magnet, and an end of the first voice coil away from the first vibrating diaphragm movably extends into the gap.

In an implementation of the technical solution, the high-frequency loudspeaker component includes a second housing, a second vibrating diaphragm, and a second magnet, where the second vibrating diaphragm and the second magnet are disposed on the second housing, the second vibrating diaphragm is provided with a second voice coil, the second voice coil is electrically connected to the crossover circuit board, and the second vibrating diaphragm is coaxially disposed with the first vibrating diaphragm of the low-frequency loudspeaker component.

In an implementation of the technical solution, the concave cavity serves as a high-frequency sound cavity, and the high-frequency sound cavity and the low-frequency sound cavity are independent of each other; and a projection of the concave cavity in a direction of the central axis of the vibrating diaphragm or the central axis of the magnetic circuit of the low-frequency loudspeaker component can block a central part region of the vibrating diaphragm of the low-frequency loudspeaker component.

In an implementation of the technical solution, the first housing is cup-shaped and includes an annular side wall portion and a support portion disposed on an inner wall of the annular side wall portion, the support portion divides an inner cavity of the first housing into a sound-emitting side and a ventilation side, the side wall portion is provided with a first side wall opening communicating with the sound-emitting side of the inner cavity of the first housing on the sound-emitting side, and the side wall portion is provided with a housing tweeter wire groove on the ventilation side; and the bracket is bowl-shaped and includes a bracket periphery and a bracket end, a central region of the bracket end is recessed inward to form the concave cavity, the concave cavity includes a concave cavity periphery and a concave cavity end, an inner side of the bracket is provided with a bracket rib for connecting the concave cavity periphery and the bracket periphery, an outer side of the bracket is provided with a bracket tweeter wire groove for communicating the concave cavity with the bracket periphery at a position corresponding to the bracket rib, the bracket periphery is provided with a bracket clamping protrusion at a position corresponding to the bracket tweeter wire groove, the bracket is provided on the sound-emitting side of the inner cavity of the first housing, the bracket end abuts against the support portion, the bracket periphery blocks the first side wall opening, and the bracket clamping protrusion is clamped in the first side wall opening.

In an implementation of the technical solution, the bracket periphery is provided with a bracket positioning portion, the concave cavity periphery is provided with a tweeter unit assembly portion coaxial with the bracket positioning portion, the inner cavity of the first housing is provided with a bracket fitting portion adapted to the bracket positioning portion on the sound-emitting side, and the support portion is provided with a woofer unit assembly portion coaxial with the bracket fitting portion.

In an implementation of the technical solution, a depth of the concave cavity in the direction of the central axis of the vibrating diaphragm or the central axis of the magnetic circuit of the low-frequency loudspeaker component is greater than a thickness of the high-frequency loudspeaker component in the direction, so that the high-frequency loudspeaker component is integrally accommodated in the concave cavity; the support portion is provided with a plurality of woofer air holes communicating with the sound-emitting side and the ventilation side, the low-frequency loudspeaker component is provided with a first vibrating diaphragm, the first vibrating diaphragm is circular, the woofer air holes are disposed in an annular shape or a fan shape around a center of the first vibrating diaphragm, and projections of the woofer air holes in an axis direction of the first vibrating diaphragm fall within an annular region of the first vibrating diaphragm away from an axis thereof; the support portion is provided with an annular rib and spacing ribs on the ventilation side, and the spacing ribs divide an annular region between the annular rib and the side wall portion into a plurality of woofer air cavities corresponding to the woofer air holes; and a bottom of the first housing is provided with a bottom plate, the bottom plate is annular and is configured to cover the woofer air cavities, and the bottom plate is provided with bottom plate openings corresponding to positions of the woofer air holes.

In an implementation of the technical solution, the woofer air holes are disposed in the fan shape around the center of the first vibrating diaphragm, a region not provided with the woofer air holes in the annular region between the annular rib and the side wall portion is configured to provide the crossover circuit board, and a position of the crossover circuit board corresponds to a position of the first side wall opening; three spacing ribs adjacent to the crossover circuit board are sequentially provided with a first cable slot, a second cable slot, and a third cable slot, the first cable slot is close to the annular rib, the second cable slot is close to the side wall portion, the third cable slot is close to the annular rib, and the side wall portion is provided with a side wall slot at a position close to the third cable slot; and an outer periphery of the side wall portion is provided with a housing woofer wire groove at a position corresponding to the crossover circuit board, and the support portion is provided with a housing woofer wire relief groove communicating with the housing woofer wire groove on the sound-emitting side.

In an implementation of the technical solution, a thickness of the high and low dual-frequency composite loudspeaker unit in the direction of the central axis of the vibrating diaphragm or the central axis of the magnetic circuit of the low-frequency loudspeaker component ranges from 8 mm to 18 mm, and a diameter of the first housing ranges from 30 mm to 50 mm; or a diameter of the first vibrating diaphragm provided in the low-frequency loudspeaker component ranges from 30 mm to 50 mm.

In an implementation of the technical solution, an annular side wall portion is formed on the first housing, and the bracket is fixed in the side wall portion.

Another technical solution of this application provides an audio device, including the high and low dual-frequency composite loudspeaker unit in the above technical solution. The audio device is an earphone, a sound box, or the like.

It should be understood that the above general descriptions and the following detailed descriptions are exemplary and explanatory only and are not intended to limit this application.

### BRIEF DESCRIPTION OF THE DRAWINGS

The above and other objectives, features and advantages of this application will become more apparent by describing exemplary implementations of this application in more detail with reference to the accompanying drawings, and in the exemplary implementations of this application, the same reference numerals generally represent the same parts.

FIG. 1 is a schematic structural diagram of a loudspeaker unit shown in an embodiment of this application.

FIG. 2 is a schematic cross-sectional view of a loudspeaker unit shown in an embodiment of this application.

FIG. 3 is a schematic exploded view of a loudspeaker unit shown in an embodiment of this application.

FIG. 4 is a schematic structural diagram of a sound-emitting side of a first housing shown in an embodiment of this application.

FIG. 5 is a schematic structural diagram of a ventilation side of a first housing shown in an embodiment of this application.

FIG. 6 is a schematic diagram of a front structure of a bracket shown in an embodiment of this application.

FIG. 7 is a schematic diagram of a back structure of a bracket shown in an embodiment of this application.

FIG. 8 is a schematic assembly view of audio cables of a loudspeaker shown in an embodiment of this application.

### DESCRIPTION OF REFERENCE NUMERALS

1—low-frequency loudspeaker component; 11—first housing; 111—side wall portion; 1111—housing tweeter wire groove; 1112—housing woofer wire groove; 1113—housing woofer wire relief groove; 112—support portion; 113—first side wall opening; 114—woofer unit assembly portion; 115—woofer air hole; 1151—woofer air cavity; 116—annular rib; 117—spacing rib; 118—first cable slot; 119—second cable slot; 120—third cable slot; 121—side wall slot; 12—first vibrating diaphragm; 13—first voice coil; 14—first magnet; 15—magnetic yoke; 16—gap;
2—high-frequency loudspeaker component; 21—second housing; 22—second vibrating diaphragm; 23—second voice coil; and 24—second magnet;
3—bracket; 31—low-frequency sound hole; 32—concave cavity; 321—concave cavity periphery; 322—concave cavity end; 33—bracket periphery; 34—bracket end; 35—bracket rib; 36—bracket tweeter wire groove; and 37—bracket clamping protrusion; and
4—crossover circuit board; 5—protective cover; 51—high-frequency sound hole; 6—bottom plate; 61—bottom plate opening; 7—dustproof mesh; and 8—audio cable.

### DETAILED DESCRIPTION OF EMBODIMENTS

The technical solutions in some embodiments of this application will be clearly and completely described below with reference to the accompanying drawings in some embodiments of this application. Apparently, the described embodiments are merely some rather than all of the embodiments of this application. Based on the embodiments in this application, all the other embodiments obtained by those of ordinary skill in the art without any creative effort fall within the scope of protection of this application.

The technical solutions in the embodiments of this application will be described in detail below with reference to the accompanying drawings.

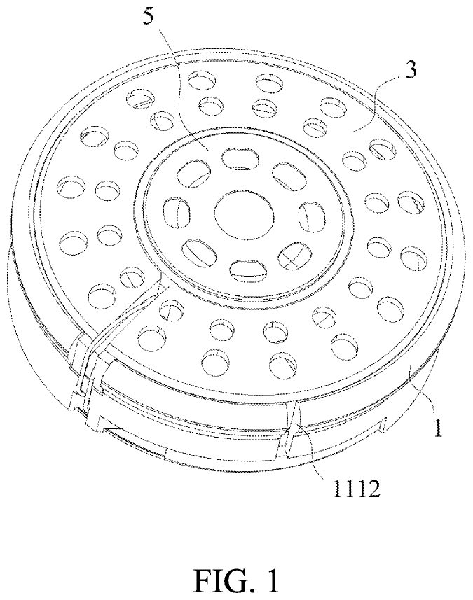

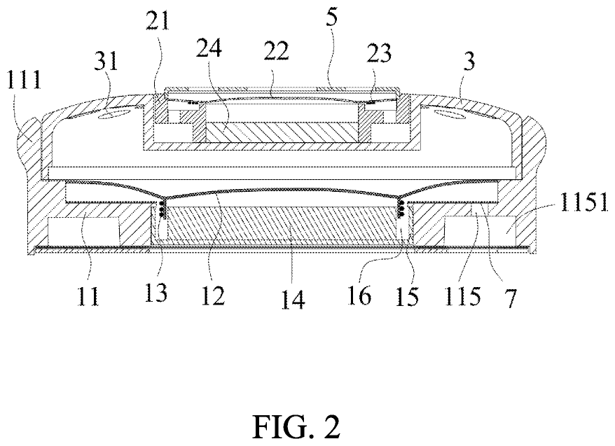

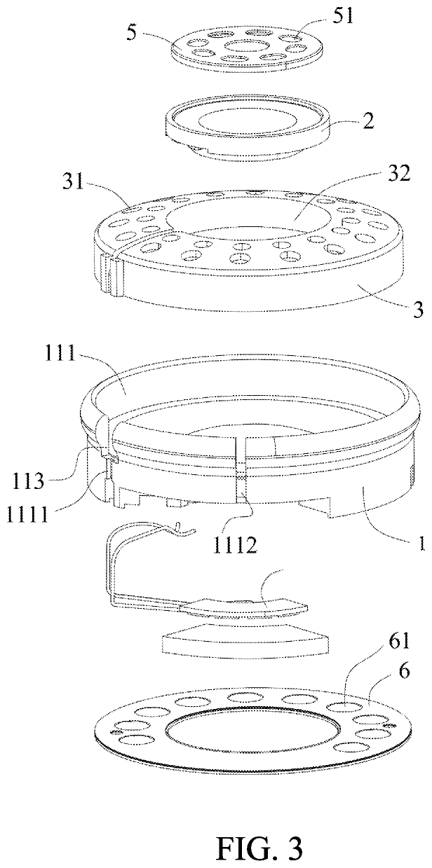

As shown in FIG. 1 to FIG. 3, this embodiment provides a high and low dual-frequency composite loudspeaker unit, including a low-frequency loudspeaker component 1 and a high-frequency loudspeaker component 2, where the low-frequency loudspeaker component 1 includes a first housing 11, the first housing 11 is provided with a bracket 3, a low-frequency sound cavity is formed between the bracket 3 and the first housing 11, the high-frequency loudspeaker component 2 is disposed on the bracket 3, and the high-frequency loudspeaker component 2 is located on a central axis of a vibrating diaphragm or a central axis of a magnetic circuit of the low-frequency loudspeaker component 1; and
the high and low dual-frequency composite loudspeaker unit further includes a crossover circuit board 4 disposed on the first housing 11, the low-frequency loudspeaker component 1 and the high-frequency loudspeaker component 2 are electrically connected to the crossover circuit board 4 respectively, the crossover circuit board 4 is configured to receive an inputted audio signal and divide the audio signal into a low-frequency part and a high-frequency part, the low-frequency loudspeaker component 1 is configured to reproduce the low-frequency part in the audio signal, and the high-frequency loudspeaker component 2 is configured to reproduce the high-frequency part in the audio signal.

The high and low dual-frequency composite loudspeaker unit can be applied to audio devices such as earphones and sound boxes. An independent high-frequency loudspeaker component 2 is integrated on the central axis of the low-frequency loudspeaker component 1, and the high-frequency loudspeaker component 2 is connected to the crossover circuit board 4 through independent lead wires, and works together with the low-frequency loudspeaker component 1 through the crossover circuit board 4.

The technical solution integrates generation sources of low-frequency and high-frequency sound waves in a physical structure while maintaining independent electro-acoustic conversion characteristics thereof, so that the low-frequency part can focus on expressing rich and deep bass, and the high-frequency part can accurately restore delicate high-frequency details, thereby significantly improving overall sound quality performance width and clarity of an earphone without significantly increasing a volume of the earphone.

In this embodiment, the bracket 3 is provided with a plurality of low-frequency sound holes 31, the low-frequency sound holes 31 are configured to communicate with the low-frequency sound cavity, and all the low-frequency sound holes 31 are uniformly distributed around the high-frequency loudspeaker component 2. In this way, sound emitted by the low-frequency loudspeaker component 1 can be transmitted outward through the low-frequency sound holes 31 without affecting the sound output of the high-frequency loudspeaker component 2.

Specifically, a concave cavity 32 is formed in a central position of the bracket 3, the high-frequency loudspeaker component 2 is accommodated in the concave cavity 32, and the concave cavity 32 is not in communication with the low-frequency sound cavity. The high-frequency loudspeaker component 2 is accommodated in the concave cavity 32 to facilitate the assembly, and the concave cavity 32 is isolated from the low-frequency sound cavity, so that high and low frequencies do not affect each other.

Further, the bracket 3 is further provided with a protective cover 5, the protective cover 5 covers the concave cavity 32, the protective cover 5 is provided with high-frequency sound holes 51 for allowing sound to pass through, and the protective cover 5 can effectively protect the high-frequency loudspeaker component 2 in the concave cavity 32.

In this embodiment, the low-frequency loudspeaker component 1 is a balanced armature type loudspeaker or a moving-coil loudspeaker. The high-frequency loudspeaker component 2 is a balanced armature type loudspeaker or a moving-coil loudspeaker.

In this embodiment, the low-frequency loudspeaker component 1 includes a first housing 11, a first vibrating diaphragm 12, and a first magnet 14, where the first vibrating diaphragm 12 and the first magnet 14 are disposed on the first housing 11, the first vibrating diaphragm 12 is provided with a first voice coil 13, the first voice coil 13 is connected to the first vibrating diaphragm 12 by bonding, and the first voice coil 13 is electrically connected to the crossover circuit board 4.

Further, the low-frequency loudspeaker component 1 further includes a magnetic yoke 15, the first magnet 14 is disposed on the magnetic yoke 15, the magnetic yoke 15 is disposed on the first housing 11, an annular gap 16 is formed between the magnetic yoke 15 and the first magnet 14, and an end of the first voice coil 13 away from the first vibrating diaphragm 12 movably extends into the gap 16.

In this embodiment, the high-frequency loudspeaker component 2 includes a second housing 21, a second vibrating diaphragm 22, and a second magnet 24, where the second vibrating diaphragm 22 and the second magnet 24 are disposed on the second housing 21, the second housing 21 and the bracket 3 are fixed, the second vibrating diaphragm 22 is provided with a second voice coil 23, the second voice coil 23 is connected to the second vibrating diaphragm 22 by bonding, the second voice coil 23 is electrically connected to the crossover circuit board 4, and the second vibrating diaphragm 22 is coaxially disposed with the first vibrating diaphragm 12 of the low-frequency loudspeaker component 1.

In this embodiment, an annular side wall portion 111 is formed on the first housing 11, the bracket 3 is fixed in the side wall portion 111, and the bracket 3 and the side wall portion 111 may be fixed by adhesive bonding, screws, or buckle structures.

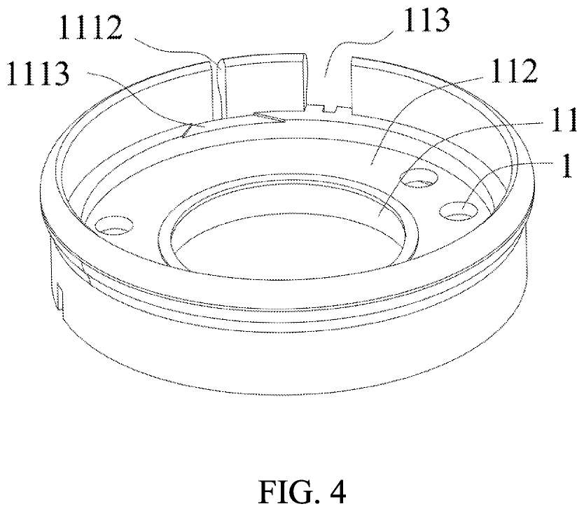

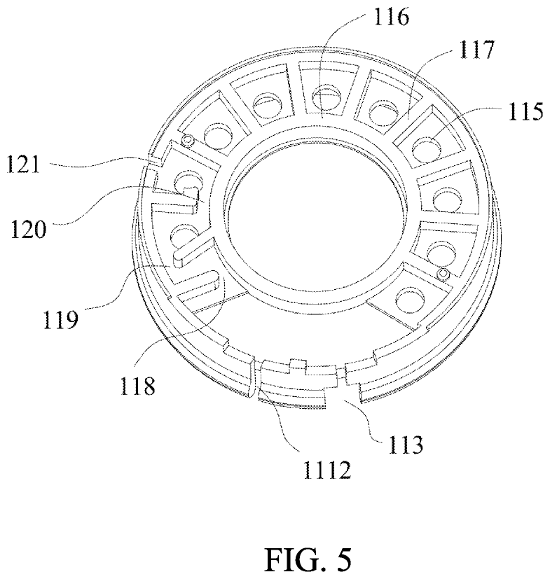

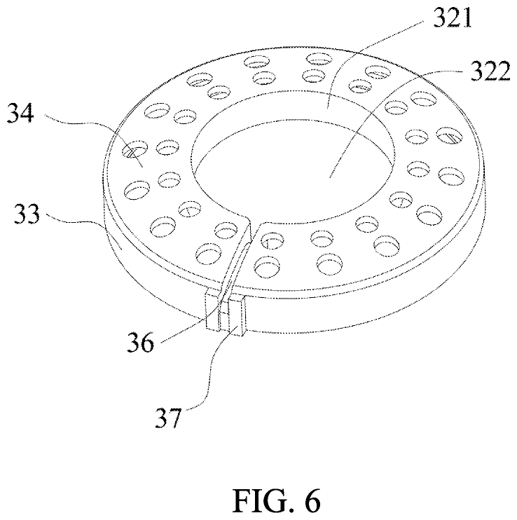

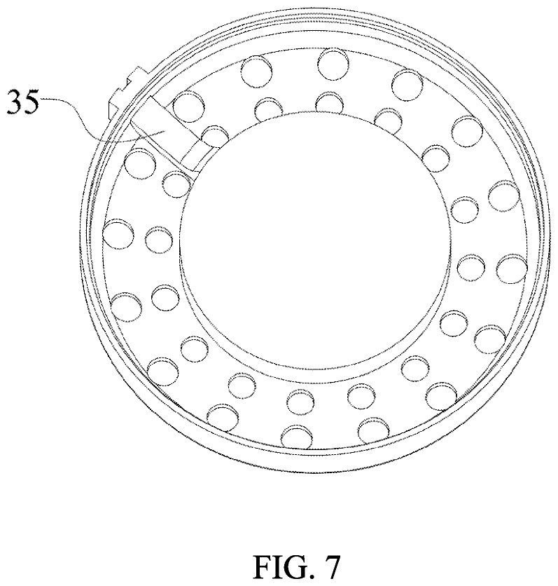

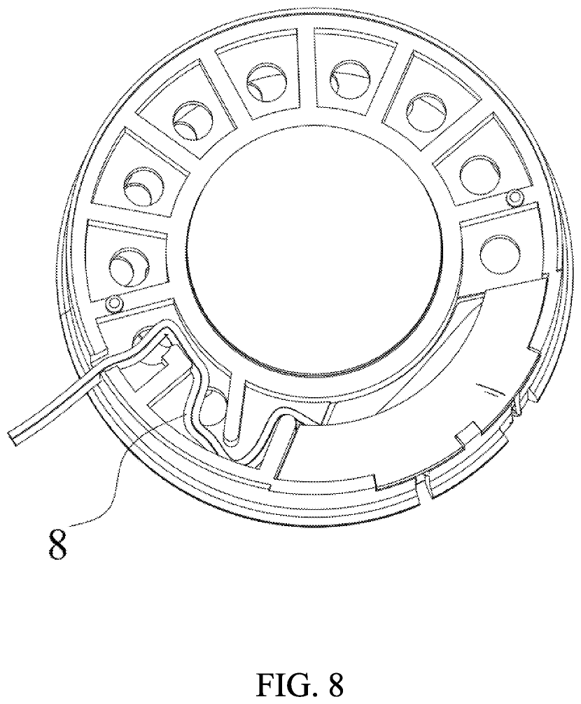

Referring to FIG. 4 to FIG. 8, further, the concave cavity 32 serves as a high-frequency sound cavity, and the high-frequency sound cavity and the low-frequency sound cavity are independent of each other; and a projection of the concave cavity 32 in a direction of the central axis of the vibrating diaphragm or the central axis of the magnetic circuit of the low-frequency loudspeaker component 1 can block a central part region of the vibrating diaphragm of the low-frequency loudspeaker component 1. The high-frequency sound cavity and the low-frequency sound cavity are independent of each other, and the high-frequency sound cavity is concavely formed in a height space of the low-frequency sound cavity. High-frequency and low-frequency sound-emitting units may be disposed coaxially without increasing the overall thickness, so as to conform to the small space design idea of headphones. Moreover, the high-frequency space and the low-frequency space are independent, so that high and low frequencies cannot interfere with each other. In addition, the concave cavity 32, namely the position where the high-frequency sound-emitting unit is placed, physically blocks the central region of the vibrating diaphragm of the low-frequency sound-emitting unit in a projection direction of the axis of the low-frequency loudspeaker, so that the low-frequency part that emits sound at the edge of the vibrating diaphragm of the low-frequency sound-emitting unit is more prominent, so as to play a role in physical crossover. Specifically, the independent arrangement of the high-frequency sound cavity and the low-frequency sound cavity can effectively avoid the mutual penetration and superposition of high-frequency sound waves and low-frequency sound waves during propagation, thereby eliminating the occurrence of the crosstalk phenomenon, ensuring clear and transparent high-frequency sound and rich and powerful low-frequency sound, and significantly improving the sound quality performance of earphones. The design that the high-frequency sound cavity is concavely formed in the height space of the low-frequency sound cavity breaks the limitation of the traditional coaxial dual-unit arrangement that requires superposing up and down, resulting in an increase in overall thickness, effectively controls the overall thickness of the loudspeaker unit while achieving coaxial arrangement of high-frequency and low-frequency sound-emitting units, perfectly adapts to the limited installation space inside earcups of headphones, and meets the design requirements of miniaturization and lightweight of headphones. In addition, the physical blocking of the concave cavity 32 to the central region of the vibrating diaphragm of the low-frequency loudspeaker component 1 can limit the vibration amplitude of the central region of the vibrating diaphragm, so that the region at the edge of the vibrating diaphragm becomes a main low-frequency sound-emitting region. By utilizing the characteristic that the edge vibration of the vibrating diaphragm is more suitable for low-frequency propagation, the low-frequency sound-emitting effect is enhanced, the interference caused by high-frequency vibration in the central region of the vibrating diaphragm is reduced simultaneously, and the physical crossover between high and low frequencies is achieved. By cooperating with the electronic crossover of the crossover circuit board 4, the crossover effect is further optimized, the separation of high and low frequency sounds is more thorough, and the sound quality level is more distinct.

Further, the first housing 11 is cup-shaped and includes an annular side wall portion 111 and a support portion 112 disposed on an inner wall of the annular side wall portion 111, the support portion 112 divides an inner cavity of the first housing 11 into a sound-emitting side and a ventilation side, the side wall portion 111 is provided with a first side wall opening 113 communicating with the sound-emitting side of the inner cavity of the first housing 11 on the sound-emitting side, and the side wall portion 111 is provided with a housing tweeter wire groove 1111 on the ventilation side; and the bracket 3 is bowl-shaped and includes a bracket periphery 33 and a bracket end 34, a central region of the bracket end 34 is recessed inward to form the concave cavity 32, and the concave cavity 32 includes a concave cavity periphery 321 and a concave cavity end 322. Because the bracket 3 is a thin-shell shielding cover for the low-frequency loudspeaker component 1, the rigidity of the concave cavity 32 is insufficient. In order to prevent the high-frequency loudspeaker component 2 from being affected by sound waves of the low-frequency loudspeaker component 1, an inner side of the bracket 3 is provided with a bracket rib 35 for connecting the concave cavity periphery 321 and the bracket periphery 33. The bracket rib 35 effectively enhances the rigidity of the concave cavity 32. Moreover, due to the arrangement of the bracket rib 35, an outer side of the thin-shell bracket 3 can have space to bury cables for power supply and signals of the high-frequency loudspeaker component 2. Specifically, the outer side of the bracket 3 is provided with a bracket tweeter wire groove 36 for communicating the concave cavity 32 with the bracket periphery 33 at a position corresponding to the bracket rib 35, and the high-frequency loudspeaker component 2 is disposed coaxially in the concave cavity 32. In order to avoid the rotation thereof, the bracket periphery 33 is provided with a bracket clamping protrusion 37 at a position corresponding to the bracket tweeter wire groove 36, the bracket is provided on the sound-emitting side of the inner cavity of the first housing 11, the bracket end 34 abuts against the support portion 112, the bracket periphery 33 blocks the first side wall opening 113, and the bracket clamping protrusion 37 is clamped in the first side wall opening 113, so as to limit the rotation of the high-frequency loudspeaker component 2 in the concave cavity 32. Furthermore, the inside of the first side wall opening 113 also serves as a wiring space for the high-frequency loudspeaker component.

Further, in order to make the low-frequency loudspeaker component 1 and the high-frequency loudspeaker component 2 coaxial and easy to produce and assemble, it is necessary to design an assembly positioning structure between the low-frequency loudspeaker component and the high-frequency loudspeaker component. Specifically, the bracket periphery 33 is provided with a bracket positioning portion, the concave cavity periphery 321 is provided with a tweeter unit assembly portion coaxial with the bracket positioning portion, the inner cavity of the first housing 11 is provided with a bracket fitting portion adapted to the bracket positioning portion on the sound-emitting side, and the support portion 112 is provided with a woofer unit assembly portion 114 coaxial with the bracket fitting portion. The above structure ensures that after the high-frequency loudspeaker component 2 is assembled in place, the high-frequency loudspeaker component is coaxial with the low-frequency loudspeaker component 1.

Further, in order to make the thickness of the high and low dual-frequency composite loudspeaker unit equivalent to the overall thickness of the low-frequency loudspeaker component 1, a depth of the concave cavity 32 in the direction of the central axis of the vibrating diaphragm or the central axis of the magnetic circuit of the low-frequency loudspeaker component 1 is set to be greater than a thickness of the high-frequency loudspeaker component 2 in the direction, so that the high-frequency loudspeaker component 2 is integrally accommodated in the concave cavity 32. Based on this, the overall thickness of the high and low dual-frequency composite loudspeaker unit will be maintained consistent with the thickness of a single low-frequency loudspeaker component. However, the concave cavity 32 will occupy the axial space of the low-frequency sound cavity, so that the stroke of the first vibrating diaphragm 12 provided in the low-frequency loudspeaker component 1 is limited. In order to exert a better bass effect within the limited stroke of the first vibrating diaphragm 12, a ventilation structure on the ventilation side is also specially designed for the low-frequency loudspeaker component. The ventilation structure aims to concentrate the air passing through the woofer air holes 115 on an outer ring part of the first vibrating diaphragm 12 in an air suction state on the ventilation side. Specifically, the support portion 112 is provided with a plurality of woofer air holes 115 communicating with the sound-emitting side and the ventilation side, the low-frequency loudspeaker component 1 is provided with a first vibrating diaphragm 12, the first vibrating diaphragm 12 is circular, the woofer air holes 115 are disposed in an annular shape or a fan shape around a center of the first vibrating diaphragm 12, and projections of the woofer air holes 115 in an axis direction of the first vibrating diaphragm 12 fall within an annular region of the first vibrating diaphragm 12 away from an axis thereof; the support portion 112 is provided with an annular rib 116 and spacing ribs 117 on the ventilation side, and the spacing ribs 117 divide an annular region between the annular rib 116 and the side wall portion 111 into a plurality of woofer air cavities 1151 corresponding to the woofer air holes 115; and a bottom of the first housing 11 is provided with a bottom plate 6, the bottom plate 6 is annular and is configured to cover the woofer air cavities 1151, and the bottom plate 6 is provided with bottom plate openings 61 corresponding to positions of the woofer air holes 115.

Based on the ventilation structure, in the air suction state on the ventilation side, external air enters the woofer air cavities 1151 through the bottom plate openings 61 on the bottom plate 6. In this case, the woofer air cavities 1151 serve as a “reservoir” that can quickly store sufficient air to avoid the problem of insufficient air supply during air suction. The external air is limited and guided by the spacing ribs 117, and the air will pass through the woofer air holes 115 in a concentrated manner to act on the outer ring part of the first vibrating diaphragm 12. Compared to the design without the ventilation structure, the concentrated air can provide more sufficient and accurate thrust for the outer ring of the first vibrating diaphragm 12, so as to effectively compensate for the problem of insufficient thrust caused by the limited stroke of the first vibrating diaphragm 12 after the concave cavity 32 occupies the axial space of the low-frequency sound cavity. In an exhaust state on the ventilation side, the outer ring part of the first vibrating diaphragm 12 accurately corresponds to the positions of the woofer air holes 115. In this case, when the outer ring of the first vibrating diaphragm 12 moves towards the exhaust side, the air on the surface thereof can be quickly discharged to the woofer air cavities 1151 through the woofer air holes 115, the woofer air cavities 1151 serving as temporary buffer space can temporarily accommodate the discharged air to avoid resistance caused by the instantaneous accumulation of the air, and the air is then discharged to the outside through the bottom plate openings 61, thereby greatly reducing the obstruction of air resistance to the movement of the vibrating diaphragm. Due to the synergistic effect of “increasing power during air suction and reducing resistance during exhaust”, the displacement obtained by the outer ring of the first vibrating diaphragm 12 in the axis direction is significantly greater than that of the inner ring, a larger displacement of the outer ring can effectively enhance the amplitude of low-frequency sound waves and increase the loudness and depth of low-frequency sound, the vibration of the outer ring is more stable simultaneously, the low-frequency distortion caused by segmented vibration can be reduced, and the low-frequency sound is richer and more layered. In conclusion, even if the concave cavity 32 occupies the axial space of the low-frequency sound cavity, resulting in limited overall stroke of the first vibrating diaphragm 12, the accurate design of the ventilation structure can enhance the vibration effect of the outer ring of the first vibrating diaphragm 12 in a targeted manner, so as to achieve better low-frequency performance than a traditional single unit, perfectly solve the technical contradiction between “dual-unit coaxial arrangement without increasing thickness” and “no damage of low-frequency sound quality”, and balance structural compactness and acoustic performance. The woofer air hole 115 is further provided with a dustproof mesh 7, which can prevent dust and foreign matters from entering the low-frequency sound cavity and damaging the low-frequency loudspeaker component 1 without affecting the intake and exhaust of the low-frequency sound cavity.

Further, the woofer air holes 115 are disposed in the fan shape around the center of the first vibrating diaphragm 12, a region not provided with the woofer air holes 115 in the annular region between the annular rib 116 and the side wall portion 111 is configured to provide the crossover circuit board 4, and a position of the crossover circuit board 4 corresponds to a position of the first side wall opening 113. Three spacing ribs 117 adjacent to the crossover circuit board 4 are sequentially provided with a first cable slot 118, a second cable slot 119, and a third cable slot 120, the first cable slot 118 is close to the annular rib 116, the second cable slot 119 is close to the side wall portion 111, the third cable slot 120 is close to the annular rib 116, and the side wall portion 111 is provided with a side wall slot 121 at a position close to the third cable slot 120. The core purpose of the design of the above cable slots is to guide an audio cable 8 of the crossover circuit board 4 to achieve regular W-shaped clamping fixation. The specific wiring logic is as follows: after being led out from the crossover circuit board 4, the audio cable 8 is first clamped into the first cable slot 118 close to the annular rib 116, then extends to and is clamped to the second cable slot 119 close to the side wall portion 111, subsequently is clamped to the third cable slot 120 close to the annular rib 116, and finally is led out through the side wall slot 121 on the side wall portion 111, so that the entire audio cable is clamped in each cable slot and the side wall slot 121 in a W shape. The W-shaped clamping structure has the beneficial effects that when the audio cable is dragged by an external force, the dragging force will be uniformly dispersed to act on the first cable slot 118, the second cable slot 119, the third cable slot 120, and the side wall slot 121, and the dragging force is counteracted through the limiting effect of each slot to prevent the dragging force from being directly transmitted to welding points of the audio cable and the crossover circuit board 4, thereby effectively preventing the detachment of welding points and the breakage of the cable, and ensuring the stability and reliability of electrical signal transmission.

An outer periphery of the side wall portion 111 is provided with a housing woofer wire groove 1112 at a position corresponding to the crossover circuit board 4, and the support portion 112 is provided with a housing woofer wire relief groove 1113 communicating with the housing woofer wire groove 1112 on the sound-emitting side. This part of the structure is designed to provide a connecting cable between the low-frequency loudspeaker component 1 and the crossover circuit board 4, where the woofer wire groove 1112 and the woofer wire relief groove 1113 also have the function of accommodating and fixing the structural adhesive of this part of the cable.

Further, a thickness of the high and low dual-frequency composite loudspeaker unit in the direction of the central axis of the vibrating diaphragm or the central axis of the magnetic circuit of the low-frequency loudspeaker component 1 ranges from 8 mm to 18 mm; a diameter of the first housing 11 ranges from 30 mm to 50 mm; or a diameter of the first vibrating diaphragm 12 provided in the low-frequency loudspeaker component 1 ranges from 30 mm to 50 mm. The limiting core purpose of the size range is to clarify exclusive solution scenarios of this solution to solve the problem of arrangement of high and low frequency units of loudspeaker units in specific size ranges. For a loudspeaker unit with a diameter greater than 50 mm or a thickness greater than 18 mm, a coaxial dual-unit arrangement manner of superposing up and down can be directly used by increasing the cavity space without the need for special ventilation structures and space optimization design. For a loudspeaker unit with a diameter less than 30 mm or a thickness less than 8 mm, a flat multi-unit arrangement manner can be used to adapt to small audio devices such as in-ear earphones without the need for the structural design of this solution. The core application scenario of a loudspeaker unit with a thickness of 8 mm to 18 mm and a diameter of 30 mm to 50 mm (including the diameter of the first vibrating diaphragm 12) limited by this solution is a headphone. The loudspeaker unit within this size range is limited by both the earcup space of the headphone and the ergonomic design, cannot be disposed in a flat manner (the space is insufficient), and cannot be disposed coaxially in a traditional manner of superposing up and down (the thickness is increased, affecting the wearing comfort). At present, there is a technical gap in the field of arrangement of high and low dual-frequency units of headphones, and there is no mature and efficient solution yet. By combining core technologies such as the concave design of the concave cavity 32 and the optimization of the ventilation structure, on the premise that the overall thickness of the loudspeaker unit is not increased and the wearing comfort is not affected, coaxial integration of high and low dual-frequency units is achieved, and the low-frequency sound quality is prevented from being compromised to perfectly adapt to the application scenarios of headphones. In addition, this size range conforms to industrial conventional specifications of loudspeaker units of headphones, so that related parts can be purchased easily, the material and mold costs are reduced, the mass production feasibility is improved, and this size range can also be adapted to earcup and housing structures of existing headphones without significantly changing the overall structures of earphones, thereby reducing the research and development and iteration costs of products.

The embodiments of this application have been described above. The above description is exemplary and is not exhaustive, and is not limited to the disclosed embodiments. Without departing from the scope and spirit of the illustrated embodiments, many modifications and alterations are apparent to those of ordinary skill in the art. The selection of terms used herein is intended to best explain the principles and practical applications of the embodiments or technological improvements to the market, or to enable those of ordinary skill in the art to understand the embodiments disclosed herein.

What is claimed is:

1. A high and low dual-frequency composite loudspeaker unit, comprising a low-frequency loudspeaker component and a high-frequency loudspeaker component, wherein the low-frequency loudspeaker component comprises a first housing, the first housing is provided with a bracket, a low-frequency sound cavity is formed between the bracket and the first housing, the high-frequency loudspeaker component is disposed on the bracket, and the high-frequency loudspeaker component is located on a central axis of a vibrating diaphragm or a central axis of a magnetic circuit of the low-frequency loudspeaker component; and
the high and low dual-frequency composite loudspeaker unit further comprises a crossover circuit board disposed on the first housing, the low-frequency loudspeaker component and the high-frequency loudspeaker component are electrically connected to the crossover circuit board respectively, the low-frequency loudspeaker component is configured to reproduce a low-frequency part in an audio signal, and the high-frequency loudspeaker component is configured to reproduce a high-frequency part in the audio signal.

2. The high and low dual-frequency composite loudspeaker unit according to claim 1, wherein the bracket is provided with a plurality of low-frequency sound holes, the low-frequency sound holes are configured to communicate with the low-frequency sound cavity, all the low-frequency sound holes are uniformly distributed around the high-frequency loudspeaker component, a concave cavity is formed in a central position of the bracket, the high-frequency loudspeaker component is accommodated in the concave cavity, the concave cavity is not in communication with the low-frequency sound cavity, the bracket is further provided with a protective cover, the protective cover covers the concave cavity, and the protective cover is provided with high-frequency sound holes.

3. The high and low dual-frequency composite loudspeaker unit according to claim 1, wherein the low-frequency loudspeaker component is a balanced armature type loudspeaker or a moving-coil loudspeaker, and the high-frequency loudspeaker component is a balanced armature type loudspeaker or a moving-coil loudspeaker.

4. The high and low dual-frequency composite loudspeaker unit according to claim 1, wherein the low-frequency loudspeaker component comprises a first housing, a first vibrating diaphragm, and a first magnet, the first vibrating diaphragm and the first magnet are disposed on the first housing the first vibrating diaphragm is provided with a first voice coil, the first voice coil is electrically connected to the crossover circuit board, the low-frequency loudspeaker component further comprises a magnetic yoke, the first magnet is disposed on the magnetic yoke the magnetic yoke is disposed on the first housing, an annular gap is formed between the magnetic yoke and the first magnet, and an end of the first voice coil away from the first vibrating diaphragm movably extends into the gap; and
the high-frequency loudspeaker component comprises a second housing, a second vibrating diaphragm, and a second magnet, the second vibrating diaphragm and the second magnet are disposed on the second housing, the second vibrating diaphragm is provided with a second voice coil, the second voice coil is electrically connected to the crossover circuit board, and the second vibrating diaphragm is coaxially disposed with the first vibrating diaphragm of the low-frequency loudspeaker component.

5. The high and low dual-frequency composite loudspeaker unit according to claim 2, wherein the concave cavity serves as a high-frequency sound cavity, and the high-frequency sound cavity and the low-frequency sound cavity are independent of each other; and
a projection of the concave cavity in a direction of the central axis of the vibrating diaphragm or the central axis of the magnetic circuit of the low-frequency loudspeaker component is capable of blocking a central part region of the vibrating diaphragm of the low-frequency loudspeaker component.

6. The high and low dual-frequency composite loudspeaker unit according to claim 5, wherein the first housing is cup-shaped and comprises an annular side wall portion and a support portion disposed on an inner wall of the annular side wall portion, the support portion divides an inner cavity of the first housing into a sound-emitting side and a ventilation side, the side wall portion is provided with a first side wall opening communicating with the sound-emitting side of the inner cavity of the first housing on the sound-emitting side, and the side wall portion is provided with a housing tweeter wire groove on the ventilation side; and
the bracket is bowl-shaped and comprises a bracket periphery and a bracket end, a central region of the bracket end is recessed inward to form the concave cavity, the concave cavity comprises a concave cavity periphery and a concave cavity end, an inner side of the bracket is provided with a bracket rib for connecting the concave cavity periphery and the bracket periphery, an outer side of the bracket is provided with a bracket tweeter wire groove for communicating the concave cavity and the bracket periphery at a position corresponding to the bracket rib the bracket periphery is provided with a bracket clamping protrusionat a position corresponding to the bracket tweeter wire groove, the bracket is provided on the sound-emitting side of the inner cavity of the first housing, the bracket end abuts against the support portion, the bracket periphery blocks the first side wall opening, and the bracket clamping protrusion is clamped in the first side wall opening.

7. The high and low dual-frequency composite loudspeaker unit according to claim 6, wherein the bracket periphery is provided with a bracket positioning portion, the concave cavity periphery is provided with a tweeter unit assembly portion coaxial with the bracket positioning portion, the inner cavity of the first housing is provided with a bracket fitting portion adapted to the bracket positioning portion on the sound-emitting side, and the support portion is provided with a woofer unit assembly portion coaxial with the bracket fitting portion.

8. The high and low dual-frequency composite loudspeaker unit according to claim 6, wherein
a depth of the concave cavity in the direction of the central axis of the vibrating diaphragm or the central axis of the magnetic circuit of the low-frequency loudspeaker component is greater than a thickness of the high-frequency loudspeaker component in the direction, so that the high-frequency loudspeaker component is integrally accommodated in the concave cavity;
the support portion is provided with a plurality of woofer air holes communicating with the sound-emitting side and the ventilation side, the low-frequency loudspeaker component is provided with a first vibrating diaphragm, the first vibrating diaphragm is circular, the woofer air holes are disposed in an annular shape or a fan shape around a center of the first vibrating diaphragm, and projections of the woofer air holes in an axis direction of the first vibrating diaphragm fall within an annular region of the first vibrating diaphragm away from an axis thereof;
the support portion is provided with an annular rib and spacing ribs on the ventilation side, and the spacing ribs divide an annular region between the annular rib and the side wall portion into a plurality of woofer air cavities corresponding to the woofer air holes; and
a bottom of the first housing is provided with a bottom plate, the bottom plate is annular and is configured to cover the woofer air cavities, and the bottom plate is provided with bottom plate openings corresponding to positions of the woofer air holes.

9. The high and low dual-frequency composite loudspeaker unit according to claim 8, wherein the woofer air holes are disposed in the fan shape around the center of the first vibrating diaphragm, a region not provided with the woofer air holes in the annular region between the annular rib and the side wall portion is configured to provide the crossover circuit board, and a position of the crossover circuit board corresponds to a position of the first side wall opening;
three spacing ribs adjacent to the crossover circuit board are sequentially provided with a first cable slot, a second cable slot, and a third cable slot, the first cable slot is close to the annular rib, the second cable slot is close to the side wall portion, the third cable slot is close to the annular rib, and the side wall portion is provided with a side wall slot at a position close to the third cable slot; and
an outer periphery of the side wall portion is provided with a housing woofer wire groove at a position corresponding to the crossover circuit board, and the support portion is provided with a housing woofer wire relief groove communicating with the housing woofer wire groove on the sound-emitting side.

10. The high and low dual-frequency composite loudspeaker unit according to claim 5, wherein a thickness of the high and low dual-frequency composite loudspeaker unit in the direction of the central axis of the vibrating diaphragm or the central axis of the magnetic circuit of the low-frequency loudspeaker component ranges from 8 mm to 18 mm; and
a diameter of the first housing ranges from 30 mm to 50 mm, or a diameter of the first vibrating diaphragm provided in the low-frequency loudspeaker component ranges from 30 mm to 50 mm.

11. An audio device, comprising the high and low dual-frequency composite loudspeaker unit according to claim 1.
